(19) United States
(12) Patent Application Publication
(10) Pub. No.: US 2005/0233294 A1
(43) Pub. Date: Oct. 20, 2005

(54) Standardized tracking of attendance and automated detection of truancy

(76) Inventor: Frank Keitch, Pickerington, OH (US)

Correspondence Address: JENNINGS, STROUSS & SALMON, P.L.C., 201 E. WASHINGTON ST., 11TH FLOOR, PHOENIX, AZ, 85004, US

(21) Appl. No.: 11/049,486

(22) Filed: Feb. 2, 2005

Related U.S. Application Data
(60) Provisional application No. 60/541,492, filed on Feb. 2, 2004.

(51) Int. Cl. G09B 3/00

(52) U.S. Cl. 434/350; 434/362

(57) ABSTRACT

A system and method for tracking attendance and detecting truancy is disclosed. More specifically, a method for standardized tracking of attendance records throughout a school district and automated detection of unacceptable truancy is disclosed. The present system and method is capable of taking non-uniform school attendance records, standardizing them into a uniform format, combining them in a single location, tracking absences, as defined by school district policy, on a daily basis, and automatically providing notification of unacceptable truancy. The system and method is also capable of automatically notifying school officials when a response is required, and in some instances, automatically generating the appropriate response on behalf of the school district. The system and method is applicable to a wide variety of instructional environments including public and private school systems and institutions of higher learning.

### CROSS-REFERENCE TO RELATED APPLICATIONS

This application claims the benefit of priority of U.S. Patent Application Ser. No. 60/541,492 filed Feb. 2, 2004.

### FIELD OF THE INVENTION

This invention relates generally to a system and method for tracking attendance and detecting truancy, and more particularly to a system and method for standardized tracking of attendance records throughout a school district and automated detection of unacceptable truancy. The system and method is applicable to a wide variety of instructional environments, including public and private school systems and institutions of higher learning.

### BACKGROUND OF THE INVENTION

In recent years, numerous states have passed laws requiring school districts to more closely monitor student attendance and truancy. Additionally, the No Child Left Behind Act (NCLBA) recently passed by the federal government significantly raises expectations for states, local educational agencies and schools. Under the NCLBA's accountability provisions, states must describe how they will close the achievement gap and make sure all students, including those who are disadvantaged, achieve academic proficiency. This includes students who are chronically truant and absent from the classroom.

The NCLBA has prompted states and school districts to institute new policies regarding permitted absenteeism and redefine unacceptable truancy. These laws and policies require that schools take certain specified actions immediately upon a student reaching a threshold of unacceptable truancy. However, due to lack of funding, shortage of personnel, and lack of availability of sophisticated technology, most schools and school districts are ill-equipped to detect chronic truancy under the new policies, much less be able to detect on any given day when a student's absences have reached the threshold that, under the policy, triggers a required response.

Additionally, each school within a school district tracks attendance in a different manner, using different absence codes. Further, schools across a school district do not always label an “unexcused absence” as recognized by state law or school district policy as an absence, but rather as a tardy, late arrival, early dismissal, medical excuse without documentation, among others. Such variance among attendance tracking also makes it nearly impossible for school districts to currently track truancy and take appropriate action as required by their own policies and by state law.

Finally, often monetary incentives, reimbursements and other funding for schools is often linked in one way or another to student enrollment and attendance. Thus, a reliable and continuous form of attendance tracking will enable schools to maximize the monetary benefits received. This is accomplished through the present invention by the ability to detect chronic absenteeism early, and then intervene or deter chronic absenteeism before it affects monetary distributions or results in drop out, which would otherwise result in decreased enrollment (also negatively impacting a school's financial resources).

Therefore, a need exists for a system and method that standardizes absence records of all schools within a school district, automatically tracks absences on a daily basis, and provides automatic and prompt notification when an individual student's truancy reaches a threshold requiring a response.

### BRIEF DESCRIPTION OF THE DRAWINGS

FIG. 1 is an overall block diagram of the truancy tracking system according to one embodiment;

FIG. 2 is a sample school absence record for an individual student;

FIG. 3 is a sample late arrival and early dismissal chargeable absence scheme according to one embodiment of the invention;

FIG. 4 is a flowchart illustrating standardization of student absence records and daily tracking of absences according to one embodiment;

FIG. 5 is a flowchart illustrating cumulative daily absence tracking, truancy detection and response generation according to one embodiment;

FIG. 6 is a block diagram illustrating features of the truancy database according to one embodiment;

FIG. 7 is a flowchart illustrating a specific examples of threshold response generations and actions taken upon automatic notification thereof,

FIG. 8 is an example of a response letter generated according one embodiment of the present system and method;

FIG. 9 is a second example of an alternate response letter generated according one embodiment of the present system and method;

FIG. 10 is a flowchart illustrating a specific alternate embodiment for executing the system and method in Excel®; and

FIG. 11 is an example of a truancy database produced according to the alternate embodiment of FIG. 10.

### DETAILED DESCRIPTION OF VARIOUS EMBODIMENTS

The present invention is directed to system and method for tracking attendance and detecting truancy that standardizes attendance records of all schools within a school district, automatically tracks attendance on a daily basis, and provides automatic and prompt notification when an individual student's truancy reaches a threshold requiring a response. The present system and method is also capable of automatically notifying school officials when a response is required, and in some instances, automatically generating the appropriate response on behalf of the school district.

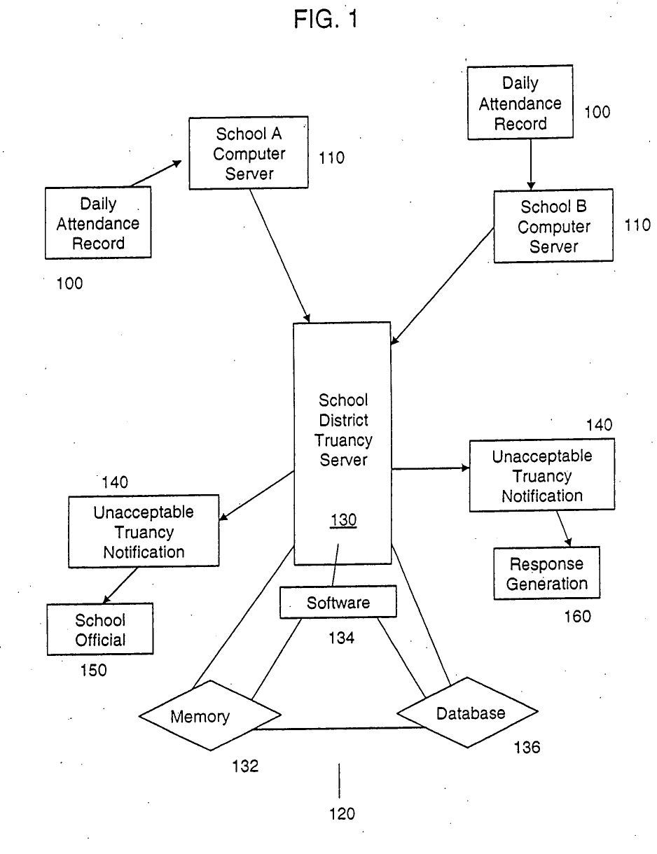

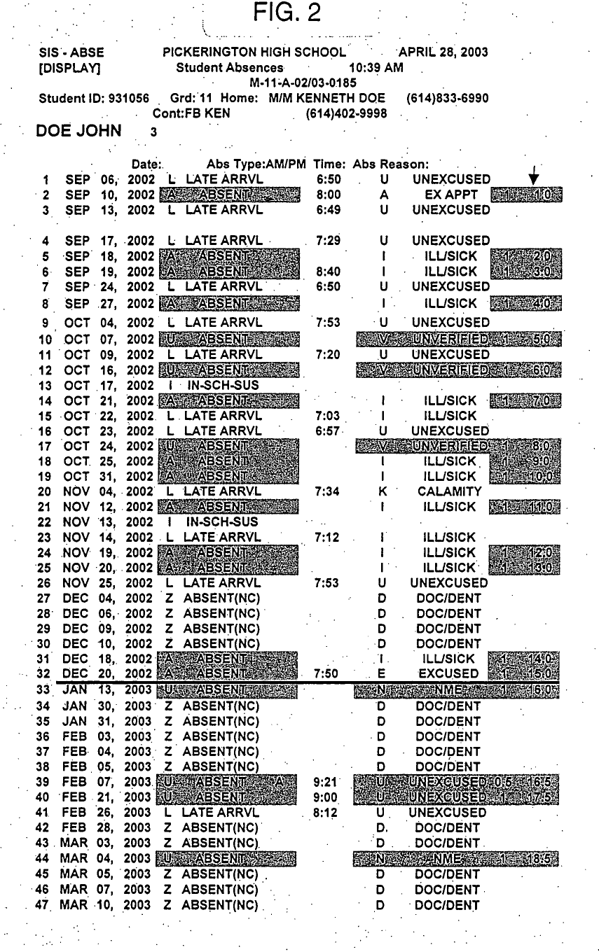

FIG. 1 illustrates one embodiment of the system for standardizing and tracking student absence records according to the present invention. According to this embodiment, the system comprises one or more schools, each school taking and recording daily absence, resulting in a daily record of student absence for each school and shown in FIG. 1 as Daily Attendance Record 100. FIG. 2 is a sample yearly school attendance record for an individual student, as maintained by the school and presently used for tracking absences in the status quo.

Table 1 below illustrates a sample Daily Attendance Record 100 (FIG. 1) for all students with recordable attendance exceptions for a given day. Recordable exceptions include, but are not limited to, the reasons listed in column two of Table 2 below.

Daily Attendance Record 100 comprises at least the Student ID corresponding to an individual student and associated with information about that student which may include, but is not limited to, the student's name, the parents' names, the student's address and phone number, the student's gender, birth date and grade, and the dean's name for that student. FIG. 2 illustrates one way in which this information is associated with the Student ID on the individual student absence record. This invention also anticipates that the present system could include a student information database that would be capable of returning this information about a student upon entry of the Student ID number.

The fifth column (Time Missed) of Table 1 may or may not be included in Daily Attendance Record 100. The Time Missed illustrates a calculation of time missed from school when the reason is a tardy, late arrival or early dismissal. It is anticipated that once the Time In or Time Out is entered in columns three and four below in the School Computer Server, the system is capable of calculating the time missed and returning a value, according to the particular schedule and late arrival/early dismissal policy of the school district.

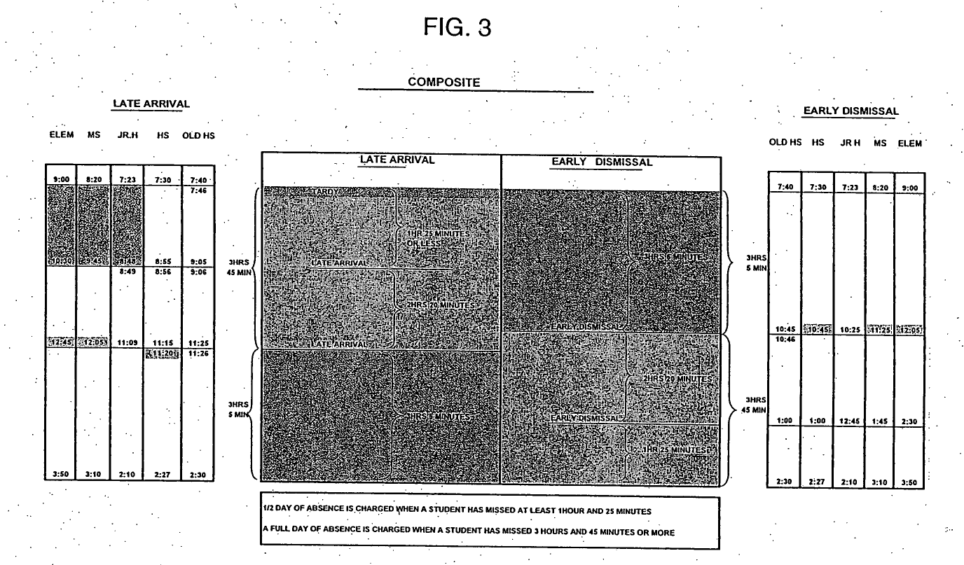

FIG. 3, as explained in detail below, illustrates how the time missed calculation is done pursuant to a tardy, late arrival and early dismissal tracking scheme according to one embodiment of the invention. For example, in FIG. 3, the high school (HS) begins at 7:30 AM and recesses at 2:27 PM. According to the school district policy in this example, tardy is recorded for arrival after 7:30 AM but before 8:55 AM, late arrival is recorded for arrival after 8:55 AM but before 11:15 AM, and early dismissal is recorded when the student leaves after 10:45 AM, but before 1:00 PM. After 1:00 PM there is no exception recorded. As illustrated in greater detail below, the amount of time missed for late arrival or early dismissal determines the amount of the chargeable absence in the standardized system.

TABLE 1
SCHOOL A ABSENCE LIST: MAR. 8, 2005

| STUDENT ID | REASON | TIME IN | TIME OUT | TIME MISSED |
|---|---|---|---|---|
| 1234 | AA | | | |
| 1235 | L | 10:00 | | 2.5 hours |
| 1236 | T | 7:46 | | 16 minutes |
| 1237 | UV | | | |
| 1238 | E | | 1:00 | 1 hour 27 minutes |

Table 2 below is an illustration of the standardization method for standardizing school attendance records and absence codes. The first two columns of Table 2 illustrate the absence key for School A. Note that in this example School A uses twenty-two different codes to record attendance exceptions.

The fourth and fifth columns of Table 2 illustrate the standardization of School A's absence key as converted by the system in one embodiment of the present invention. In this manner, the twenty-two codes used by an individual school to track attendance can be reduced to three (U=Unexcused, A=Chargeable, and E=Excused). It should be recognized that this system can also allow for a greater or smaller number of standardized codes. For example, the system could standardize all absences as either Unexcused or Excused, depending on the particular absence policy of the school district.

TABLE 2
SCHOOL ABSENCE KEY and STANDARDIZATION THEREOF

| | | | STAN- | |
|---|---|---|---|---|
| | | | DARD- | |
| SCHOOL | | SCHOOL A | IZED | STANDARIZED |
| CODE | REASON | TREATMENT | CODE | TREATMENT |
| AA | Excused | Absent | A | Chargeable |
| | Appointment | Excused | | |
| AE | Excused | Absent | A | Chargeable |
| | | Excused | | |
| AI | Ill/Sick | Absent | A | Chargeable |
| | | Excused | | |
| AO | Out of Town | Absent | A | Chargeable |
| | (Not funeral) | Excused | | |
| UU | Unexcused | Absent | U | Unexcused |
| | | Unexcused | | |
| UN | NME (no | Absent | U | Unexcused |
| | doctor note) | Unexcused | | |
| UT | Truant | Absent | U | Unexcused |
| | | Unexcused | | |
| UV | Unverified | Absent | U | Unexcused |
| | | Unexcused | | |
| T | Tardy | N/A | E | Excused* |
| L | Late Arrival | N/A | A | Chargeable** |
| E | Early | N/A | A | Chargeable** |
| | Dismissal | | | |
| S | Special | N/A | E | Excused |
| I | In School | N/A | E | Excused |
| | Suspension | | | |
| X | Suspension | Unexcused | U | Unexcused |
| | with No | | | |
| | Instruction | | | |
| Y | Suspension | Excused | E | Excused |
| | with | | | |
| | Instruction | | | |
| ZC | College Visit | Absent(NC) | E | Excused |
| | | Excused | | |
| ZD | Doctor/Dentist | Absent(NC) | E | Excused |
| | | Excused | | |
| ZF | Funeral | Absent (NC) | E | Excused |
| | | Excused | | |
| ZJ | Juv. Court | Absent (NC) | E | Excused |
| | | Excused | | |
| ZK | Calamity | Absent (NC) | E | Excused |
| | | Excused | | |
| ZL | Legal | Absent (NC) | E | Excused |
| | Appointment | Excused | | |
| ZR | Religious | Absent (NC) | E | Excused |
| | Holiday | Excused | | |
| *According to one embodiment of the invention and as illustrated in FIG. 3, tardy is recorded by the school when the student is less than an hour and twenty minutes late. According to this example, a tardy is not a chargeable absence. However, it is understood that this designation and the associated permitted lateness will vary depending on an individual's school's policy. | | | | |
| **Also according to one embodiment of the invention, late arrivals and early dismissals can be chargeable absences, for example, either as 0.5 day or 1 day. FIG. 3 illustrates an example of chargeable absences for late arrivals and early dismissals. According to the example in FIG. 3, if a student arrives between one hour and twenty-five minutes late and three hours and forty-five minutes late, the student is charged with a 0.5 | | | | |
| # day chargeable absence in the standardized system. If a student is dismissed between one hour and twenty-five minutes late and three hours and forty-five minutes early, the student is also charged with a 0.5 day chargeable absence in the standardized system. | | | | |

However, if the student is over three hours and forty-five minutes late or is dismissed over three hours and forty-five minutes early, the student is charged with 1.0 chargeable absence under the standardized system according to the disclosed method. If a student is dismissed less than one hour and twenty-five minutes early, no attendance exception is recorded.

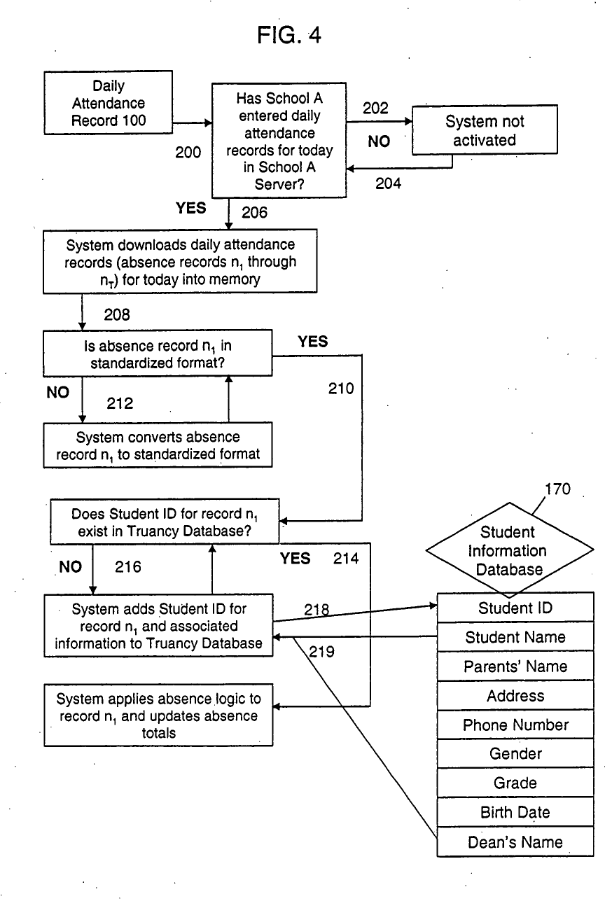

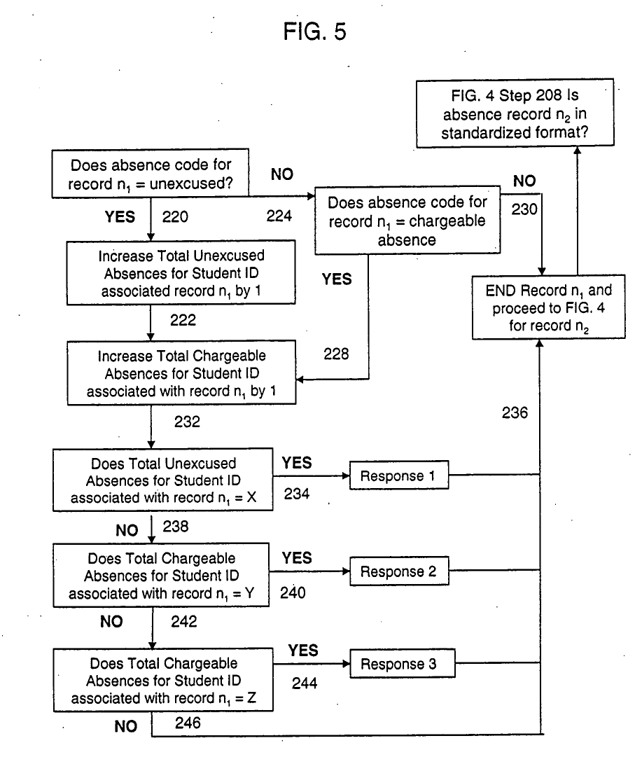

Returning now to FIG. 1, and viewing FIG. 1 in combination with the flowchart shown in FIG. 4, School A (representing one or more schools within a school district), enters Daily Attendance Record 100 into School A Computer Server 110 in step 200.

As shown in FIG. 1, the Truancy System 120, accordingly to one embodiment of the invention, comprises a School District Truancy Server 130, Software 134, Memory 132, and Truancy Database 136. The Software 134, Memory 132 and Truancy Database 136 may all reside on the Truancy Server 130 or may physically reside on separate servers or computers, but all in communication with the Truancy Server 130. Truancy Server 130 is in communication with all School Computer Servers (e.g., A and B) 110, as shown in FIG. 1.

Returning to FIG. 3, the Truancy System periodically, randomly, or continually checks the School Computer Server to determine if today's attendance records, as illustrated in Table 1 have been entered into the School Computer Server 110, as shown in step 202. If today's attendance records have not been entered, the system, with respect to School A is not activated, and the system will continue checking or check at the next predetermined or random interval for entry of attendance records, as shown in step 204.

If today's attendance records have been entered into School Computer Server 110, the system downloads Daily Attendance Record 100 into Memory 132 as shown in step 206. Daily Attendance Record 100 comprises student daily absence records n₁ through n_{T} as shown in the example in Table 1. The system then checks, in step 208, to determine whether the first record (record n₁) in Daily Attendance Record 100 is in the standardized Truancy System format, as shown in Table 2. If record n₁ already complies with the standardized Truancy System format, in step 208, the system proceeds with step 210.

In step 212, if Daily Attendance Record 100 is not in the standardized Truancy System format, the system then converts record n₁ to standardized format, according to a standardization table. Table 3 is an example of a standardization table according to one embodiment of the present invention.

TABLE 3
STANDARDIZATION CONVERSION TABLE

| SCHOOL | STANDARDIZED |
|---|---|
| CODE | CODE |
| AA | A |
| AE | A |
| AI | A |
| AO | A |
| UU | U |
| UN | U |
| UT | U |
| UV | U |
| T | E |
| L | A |
| E | A |
| S | E |
| I | E |
| X | U |
| Y | E |
| ZC | E |
| ZD | E |
| ZF | E |
| ZJ | E |
| ZK | E |
| ZL | E |
| ZR | E |

As discussed above, the standardization protocol, according to this example, converts twenty-two separate absence codes into three absence categories for streamlined and efficient absenteeism tracking according to this invention. As noted above, the number of standardized categories may be more or less, depending on the particular school district implementation of the system and method.

Once the system confirms that absence record n₁ is in standardized format, the system them proceeds according to step 210 and checks for the existence of the Student ID for record n₁ in Truancy Database 136. If the Student ID for record n₁ already exists in the Truancy Database 136, the system proceeds in step 214 to apply the absence logic and method to record n₁ which is described in detail in FIG. 5, and contained in Software 134.

However, if the Student ID for record n₁ does not exist in Truancy Database 136, the system adds the Student ID to the Truancy Database in step 216. In one embodiment of the present system and method, when the system adds the Student ID, the system can also add any other associated student information, as it exists in record n₁, or in the alternative, can add the information from a student information database associated with the Student ID (as shown in steps 218 and 219).

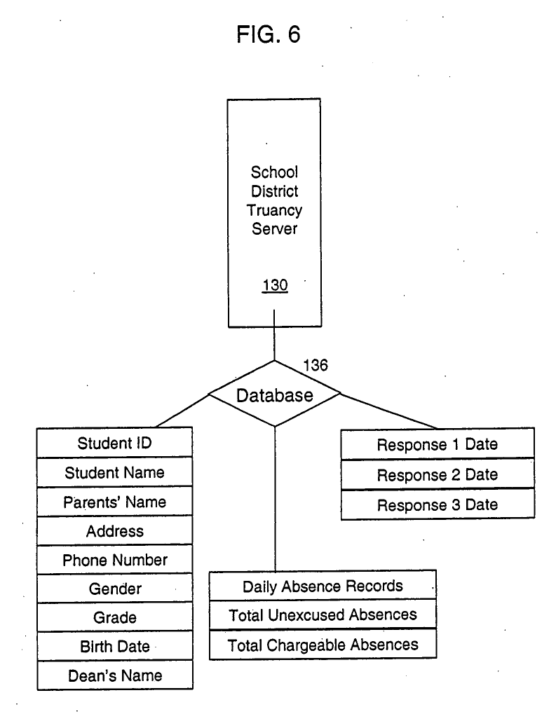

The student information existing in record n₁ or added from the associated database may include, but is not limited to, the student's name, the parents' names, the student's address and phone number, the student's gender, birth date and grade, and the dean's name for that student. As shown in FIG. 6, the Truancy Database 136 contains the student information associated with the Student ID. Such student information is then used in the automatic response generation steps described below.

The Truancy Database, as illustrated in FIG. 6, also includes information on total absences. As shown in FIG. 6, and as discussed in the example above, total absences are reflected in the Truancy Database 136 as Total Unexcused Absences and Total Chargeable Absences. However, it is envisioned that the present system and method can be tailored according to the absence designations and policies of individual school districts. Truancy Database 136 may also optionally include the daily absence records, in standardized format, as converted from the school's Daily Attendance Records 100.

A illustrative sample Truancy Database is shown in Table 4 below.

TABLE 4
SCHOOL DISTRICT TRUANCY DATABASE

| | | DAILY | TOTAL | TOTAL |
|---|---|---|---|---|
| STUDENT | STUDENT | ABSENCE | UNEXCUSED | CHARGEABLE |
| ID | INFORMATION | RECORD | ABSENCES | ABSENCES |
| 1234 (n₁) | Name, birth date, | U, A, E or blank | = Sum of Us | = Sum of As |
| | grade, etc. | if not absent | or | or |
| | (appears as | (column for each | = Total Us from | = Total As |
| | multiple columns) | school day) | previous day + 1, | from previous |
| | | | if record n₁ for | day + 1, if |
| | | | today = U | record n₁ for |
| | | | | today = A |
| 1235 (n₂) | John Doe | U | 4 | 10 |

Turning now to FIG. 5, once the Student ID and associated information have been determined to exist in Truancy Database 136, the system then proceeds to execute the truancy tracking method as embodied in Software 134. As shown in FIG. 5, the system determines if the absence code associated with record n₁ equals unexcused (in the above example, is coded “U”). If, as is shown in step 220, the absence code for record n₁ equals unexcused, then in step 220, the Total Unexcused Absences for Student ID associated with record n₁ is increased by 1, e.g., from 3 to 4.

In the present example, all unexcused absences are also chargeable absences; however, as indicated above, the system can be tailored to designations and policies of individual school districts. Therefore, according to the present example as illustrated by the flowchart in FIG. 5, in step 222, if the absence code for record n₁ equals unexcused, in step 222, the Total Chargeable Absences for Student ID associated with record n₁ is also increased by 1, e.g., from 9 to 10.

However, if in step 224, the absence code for record n₁ equals chargeable, only the Total Chargeable Absences for Student ID associated with record n₁ is also increased by 1, e.g., from 9 to 10. As discussed above, in one embodiment of the invention early dismissal and late arrivals may optionally be recorded as 0.5 chargeable absences. In this embodiment, the absence logic is modified to include a standardized code for half a chargeable absence, e.g., “AH.” Thus, in the same manner if the absence code for record n₁ is AH, then the Total Chargeable Absences for Student ID associated with record n₁ is increased by 0.5, rather than 1, e.g., from 9 to 9.5.

If the absence code for record n₁ does not equal chargeable absence (e.g., absence is excused (“E”)), then in step 230, the absence logic for record n₁ terminates and the system proceeds to record n₂, specifically back to FIG. 4, step 208, to determine if record n₂ is in standardized format.

Once the total absences have been updated for the day, the system executes the second part of the absence logic and determines whether the Total Unexcused Absences and Total Chargeable Absences have reached a designated threshold requiring a response. Normally, the threshold is set at total absences which school district policy or state law designate as an unacceptable level of truancy or absenteeism. However, it is envisioned that each school district will have its own policies which designate the particular threshold number of absences that require a response.

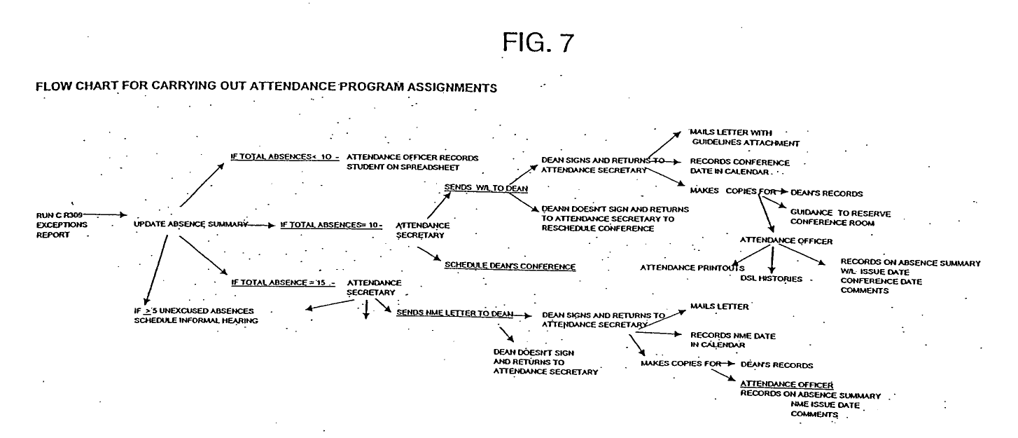

By way of example only, the following Table 5 illustrates total absences thresholds and correlating responses generated by the system. As shown in FIG. 6, Truancy Database 136 is envisioned to include the dates that automatic responses are triggered by the system and generated. Additionally, FIG. 7 is a flowchart which demonstrates specific examples of response generation in accordance with the present disclosure, including responses 1-3 shown on the table below.

These responses shown in FIG. 7 can be generated in a variety of ways, including, but not limited to, email notification, automatic letter generation, or notification of school official or truant officer, who then carries out the responses in accordance with his or her job responsibilities. For example, response 1 (informal hearing) would be generated by automatic email notification of the hearing officer, who then takes the remaining steps shown in FIG. 7.

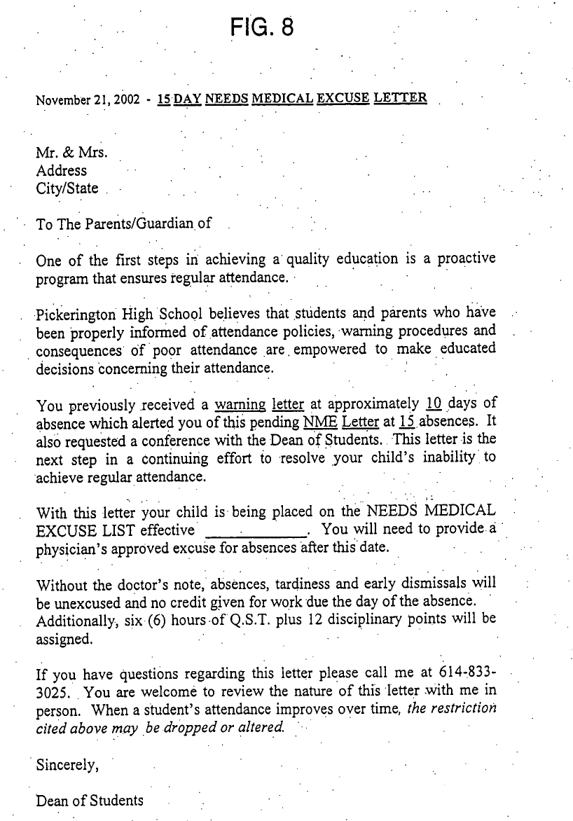

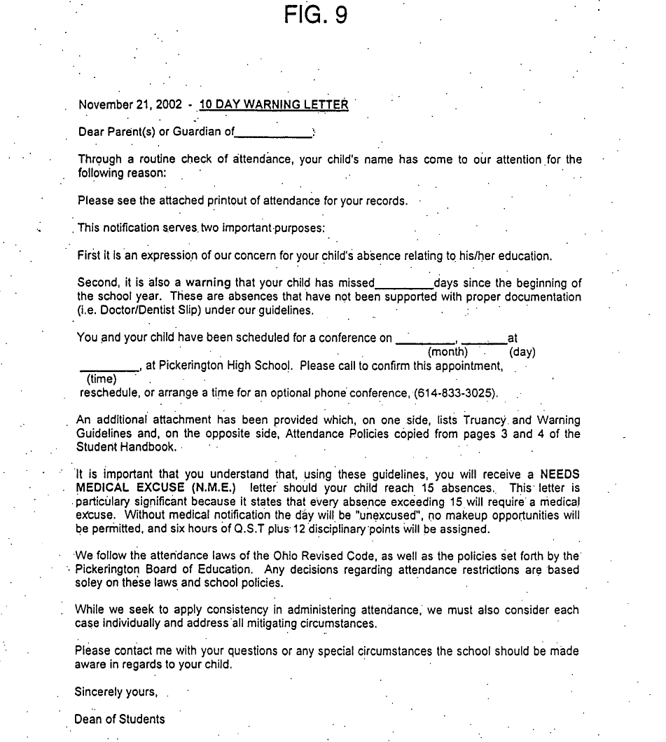

FIGS. 8 and 9, respectively, illustrate examples of either manually (by a school official) or automatically generated response letters for responses 2 and 3 in the table below. As illustrated in the table below, and in FIGS. 7-9, possible responses include, but are not limited to: (1) an Informal Truancy Hearing when a student's Total Unexcused Absences equal 5; (2) a Need Medical Excuse letter (FIG. 9) once the student's Total Chargeable Absences equal 15; and (3) a parental ten-day warning letter (FIG. 8) sent once the student's Total Chargeable Absences equal 10.

TABLE 5
SAMPLE RESPONSE GENERATION

| | TOTAL | TOTAL | RESP 1 | | |
|---|---|---|---|---|---|
| STUDENT | UNEXCUSED | CHARGEABLE | INFORMAL | RESP 2 | RESP 3 |
| ID | ABSENCES | ABSENCES | HEARING | | |
| 1234 (n₁) | 5 | 5 | Mar. 8, 2005 | | |
| 1235 (n₂) | 2 | 10 | | | Mar. 8, 2005 |
| 1236 | 4 | 15 | | Mar. 8, 2005 | |
| 1237 | 2 | 5 | | | |

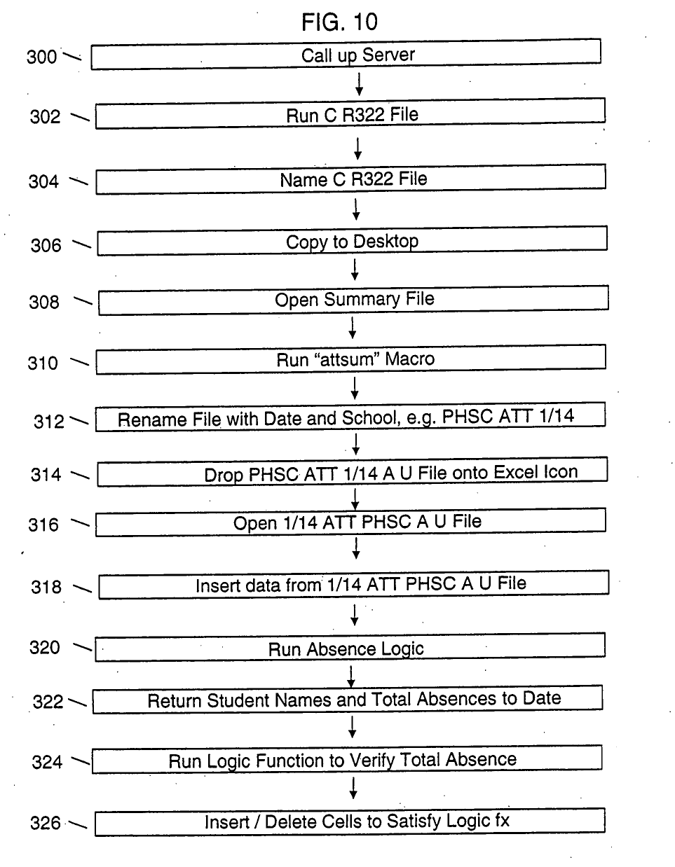

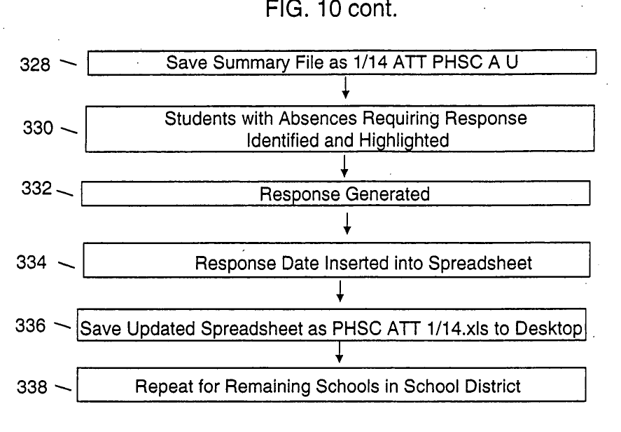

FIG. 10 illustrates an alternate embodiment for executing the method within an Excel® spreadsheet. In the example in FIG. 10, the School Computer Server is accessed in step 300. In step 300, School Attendance Record 300 is retrieved from the daily attendance information downloaded into each school's system. In Step 302, a daily report is run which converts school designations according to Table 3 to unexcused (“U”) and chargeable absences (“A”). The report is named, e.g., C R322, in step 304, saved and copied to the Truancy Server desktop in step 306. Next, in step 308 an existing summary file on the Truancy Server is opened which contains the Truancy Database 136. In step 310, an attendance summary macro (“attsum”), executing the steps in FIG. 4, is run on the report generated from the data retrieved from School A. In step 312, the file is saved and given today's date and the school name from which the data for the report was retrieved.

In step 314, this file is then dropped into Excel® in order to execute the absence logic in FIG. 5 and for verification. In steps 316 and 318, the file is opened and the report data is inserted into the Excel® spreadsheet. In step 320, the absence logic, shown in FIG. 5 is run, and in step 322, the total absences to date for the school year is generated for each student in the database.

In step 324, a verification logic function is run, in order to verify the student absence totals correspond correctly with the student names. In step 326, the Excel® spreadsheet is adjusted in order to satisfy the logic function. In this example, a verified record is indicated by a “1” and an unverifiable record is indicated by a “2” in the verification column.

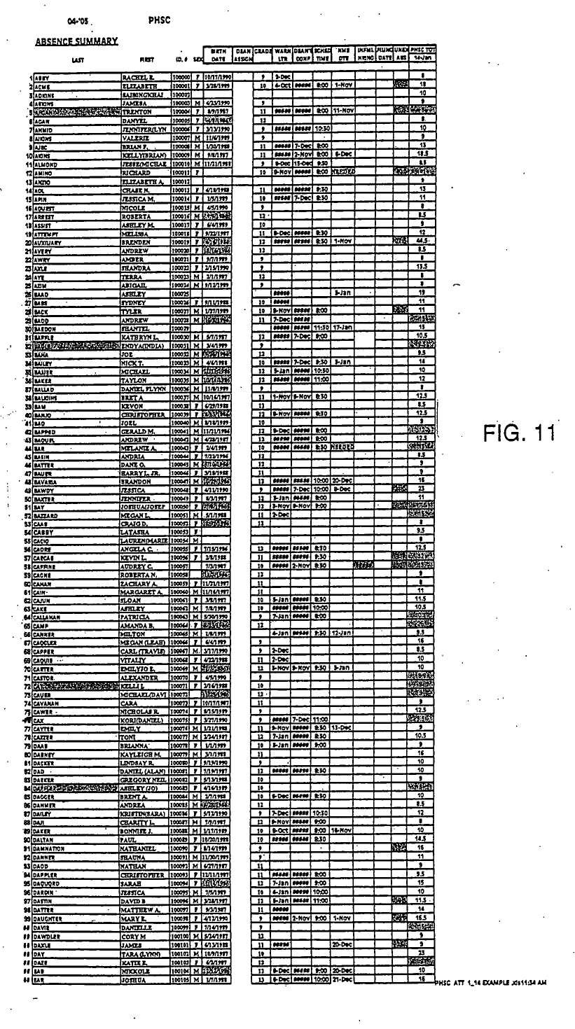

In step 328, the summary file with School A's report is saved. In step 330, the spreadsheet containing today's updated absence data is then reviewed for students that have met the criteria requiring a response, and those students are highlighted. In step 332, the response is generated, and in step 334, the date the response is generated is inserted into the report. In step 336, the spreadsheet is named with the date and school, and in step 338, the process is repeated for the next school in the school district. FIG. 11 is an example of an Absence Summary spreadsheet as generated according to the alternate embodiment of FIG. 10.

Therefore, the above system and method provide a novel way for school districts to standardize attendance tracking, automate detection of chronic absenteeism and automatically generate appropriate responses thereto. Advantages gained from implementation of such a system include increased compliance with state and federal education policy, increased student attendance through early detection of potential issues associated with chronic absenteeism, and increased monetary reward for schools that exhibit increased attendance and maintain student enrollment.

While the invention has been described with reference to a particular embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as best mode contemplated for carrying out this invention, but that the invention will include all embodiments falling within the scope of the appended claims.

1. A method for detecting absenteeism in a school district, comprising:
accessing a daily student attendance report from a school in a school district, wherein the daily student attendance report comprises a student absence record including a school absence code;
converting the student absence record to a standard school district absence record, wherein the school absence code is converted to a standard school district absence code;
recording an absence, wherein the school district absence code corresponds to a predetermined school district criteria for a recordable absence;
calculating a sum of total recordable absences; and
generating a response when the sum of total recordable absences reaches a predetermined threshold.

2. A computer-readable storage medium containing computer executable code for instructing a server computer to perform the steps of:
accessing a daily student attendance report from a school in a school district, wherein the daily student attendance report comprises a student absence record including a school absence code;
converting the student absence record to a standard school district absence record, wherein the school absence code is converted to a standard school district absence code;
recording an absence, wherein the school district absence code corresponds to a predetermined school district criteria for a recordable absence;
calculating a sum of total recordable absences; and
generating a response when the sum of total recordable absences reaches a predetermined threshold.

3. A system for detecting absenteeism in a school district, comprising:
a school computer server, wherein the school computer server is capable of storing a daily student attendance report;
a truancy server, in communication with the school computer server, wherein the truancy server is capable of
accessing a daily student attendance report from the school computer server, wherein the daily student attendance report comprises a student absence record including a school absence code;
converting the student absence record to a standard school district absence record, wherein the school absence code is converted to a standard school district absence code;
recording an absence, wherein the school district absence code corresponds to a predetermined school district criteria for a recordable absence;
calculating a sum of total recordable absences; and
generating a response when the sum of total recordable absences reaches a predetermined threshold.
